(19) United States
(12) Patent Application Publication
(10) Pub. No.: US 2026/0210810 A1
(43) Pub. Date: Jul. 23, 2026

(54) SYSTEM AND MAINTENANCE FOR CONDITION BASED MAINTENANCE OF PORT

(71) Applicant: AutoStore Technology AS, Nedre Vats (NO)

(72) Inventors: Jørgen Djuve Heggebø, Langhus (NO); Asheesh Saraswat, Heggedal (NO)

(21) Appl. No.: 19/140,447

(22) PCT Filed: Dec. 18, 2023
(86) PCT No.: PCT/EP2023/086461

§ 371 Date: Jun. 18, 2025

(30) Foreign Application Priority Data
Dec. 20, 2022 (NO) 20221371

(51) Int. Cl. G01M 99/00; B65G 1/04; G06Q 10/20

(52) U.S. Cl. CPC G01M 99/005; B65G 1/0464; G06Q 10/20

(57) ABSTRACT

A system, method, a computer program product and a software program product for condition-based maintenance of a port (502) in an automated storage and retrieval system comprising a framework structure (100) with a rail system forming a three-dimensional storage grid structure (104) for storing storage containers (106) for storing items, where the grid structure (104) forms vertical storage columns (105) each having a horizontal area defined by the size of an access opening (112) between rails of the rail system (108) that are arranged on the framework structure (100), the rail system (108) providing available routes for container handling vehicles (201) handling and transferring the storage containers (106) to and from the storage columns (105), at least one container handling vehicle (201, 301) the grid structure comprising one or more ports (502) for extracting containers (106) from the storage grid so that they can be picked, and wherein the automated storage and retrieval system is controlled by a central computer system (500), each port (502) comprises a computing device (504) connected to sensors (501) arranged to monitor components and wherein the continuously receiving, storing, processing and analysing sensor data from the sensors (501), including identifications of corresponding components and parts being monitored, comparing sensor data with reference sensor data and identifying sensor data showing discrepancies from reference sensor data, determining if the sensor data show discrepancies above a pre-set level, transmitting, from the computing device (504) to the central computer system (500) of the automated storage and retrieval system, data representing sensor data above the pre-set level, processing and analysing, in the central computer system (500) the data representing the sensor data above the pre-set level, and identifying the corresponding components and parts, and initiating, based on the analysis in the central computer system (500) maintenance of the identified components or parts.

### FIELD OF THE INVENTION

The present invention relates to an automated storage and retrieval system for storage and retrieval of containers, in particular to a system and method for condition based maintenance of a port using edge computing.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107.

However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

Keeping track of the need for maintenance of all the parts in an automated storage and retrieval system is not an easy task. Usually the service regime is based on estimated times for servicing and changing parts, or it is done when the part breaks down. This is a problem for the rest of the system since it usually requires that either parts of the entire system have to be shut down. If we were able to do a surveillance of the condition of the parts of the system like the ports, we would be able to change the parts before they break down and it has to shut down.

### SUMMARY OF THE INVENTION

The present invention is set forth and characterized in the independent claims, while the dependent claims describe other characteristics of the invention.

The present invention regards a system for determining a condition-based maintenance of ports in an automated storage and retrieval system comprising a framework structure with a rail system forming a three-dimensional storage grid structure for storing storage containers for storing items, where the grid structure forms vertical columns each having a horizontal area defined by the size of an access opening between rails of the rail system that are arranged on the framework structure, the rail system providing available routes for container handling vehicles handling and transferring the storage containers to and from the columns, at least one container handling vehicle the grid structure comprising one or more ports for extracting containers from the storage grid so that they can be picked, and wherein the automated storage and retrieval system is controlled by a central computer system, each port is connected to sensors arranged to monitor components and parts characterized in that the system comprises: a transmitter connected to the computing device and/or the sensors for transmitting data from the port to the central computer system, the computing device is connected to a storage device, and arranged to continuously receive, store, and analyse sensor data from the sensors using machine learning techniques the central computer system is adapted to process and analyse the data and initiate maintenance of the identified components and/or parts.

In one aspect, the sensors monitoring components and parts of ports comprise one or more of temperature sensor, sound sensor, humidity sensor, vibration sensor, and speed sensor.

In one aspect, the computing device uses deep learning techniques on the data in order to recognize issues at the port.

In one aspect, each port can comprise a computing device and a storage device arranged to continuously receive, store, and analyse sensor data from the sensors before sending the results to the central computer system.

In one aspect, the computing device and a storage device arranged to continuously receive, store, and analyse sensor data from the sensors can be located centrally in order to receive, store, and analyse sensor data from a plurality of ports before sending the results to the central computer system.

In one aspect, the central computer system comprises a service regime manager for creating a service regime based on the analysed data.

The present invention relates to a method for condition-based maintenance of a port in an automated storage and retrieval system comprising a framework structure with a rail system forming a three-dimensional storage grid structure for storing storage containers for storing items, where the grid structure forms vertical columns each having a horizontal area defined by the size of an access opening between rails of the rail system that are arranged on the framework structure, the rail system providing available routes for container handling vehicles handling and transferring the storage containers to and from the columns, at least one container handling vehicle the grid structure comprising one or more ports for extracting containers from the storage grid so that they can be picked, and wherein the automated storage and retrieval system is controlled by a central computer system, each port is connected to sensors arranged to monitor components and parts and wherein the method comprises the following steps: continuously receiving, storing, and analysing sensor data from the sensors using machine learning techniques, including identifications of corresponding components and parts being monitored, transmitting, using a transmitter connected to a computing device and/or the sensors to transmitting data from the port to the central computer system, processing and analysing, in the central computer system the data representing the sensor data above the pre-set level, and identifying the corresponding components and parts, and initiating, based on the analysis in the central computer system maintenance of the identified components or parts.

In one aspect, the information from the sensors comprises a registration of the problem with the component of the storage and retrieval system together with information regarding its service time and age.

In one aspect, registering and storing in the storage device the time it is determined that the data are recorded by the sensors.

In one aspect, all the sensor data showing discrepancies are transmitted from the computing device to the central computer system of the automated storage and retrieval system when a port has low or no activity.

In one aspect, all the sensor data are transmitted from the computing device to the central computer system of the automated storage and retrieval system when a port has low or no activity.

In one aspect, the central computer system comprises a service regime manager for creating a service regime based on the analysed data.

In one aspect, continuously receiving, storing, and analysing sensor data from the sensors at the computing device and the storage device located at the port before sending the results to the central computer system.

In one aspect, continuously receiving, storing, and analysing sensor data from the sensors at the computing device and the storage device located centrally arranged to continuously receive, store, and analyse sensor data from the sensors from a plurality of ports before sending the results to the central computer system.

The present invention also relates to a computer program product that when executed in a processor by a computing device is arranged to monitor operations of a port comprising the computing device which is connected to a storage device and to sensors, performs the steps of: continuously receiving, storing, processing and analysing sensor data from the sensors, including identifications of corresponding components and parts being monitored, initiating transmission, from the computing device to the central computer system of the automated storage and retrieval system, of data processing and analysing, in the central computer system the data representing the sensor data above the pre-set level, and identifying the corresponding components and parts, and initiating, based on the analysis in the central computer system maintenance of the identified components or parts.

The present invention also relates to a software program product, that when executed in a central computer system arranged to control and monitor operations of an automated storage and retrieval system performs the steps of: receiving data comprising sensor data from ports operating the automated storage and retrieval system, processing and analysing the sensor data, identifying, and initiating maintenance for components and parts according to type of maintenance needed.

This solution allows for a continuous update of the service regime based on the condition of the port which is monitored by the sensors which gather information and the gathered information is analysed using machine learning techniques.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a block diagram of the system and how the different pieces fit together.

FIG. 6 is a flow chart of the method for condition based maintenance of the ports in and retrieval system.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

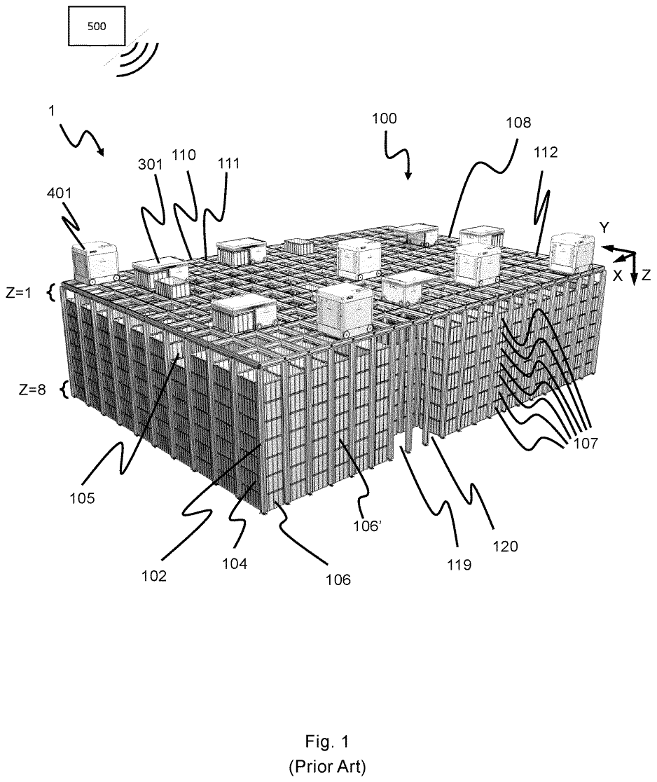

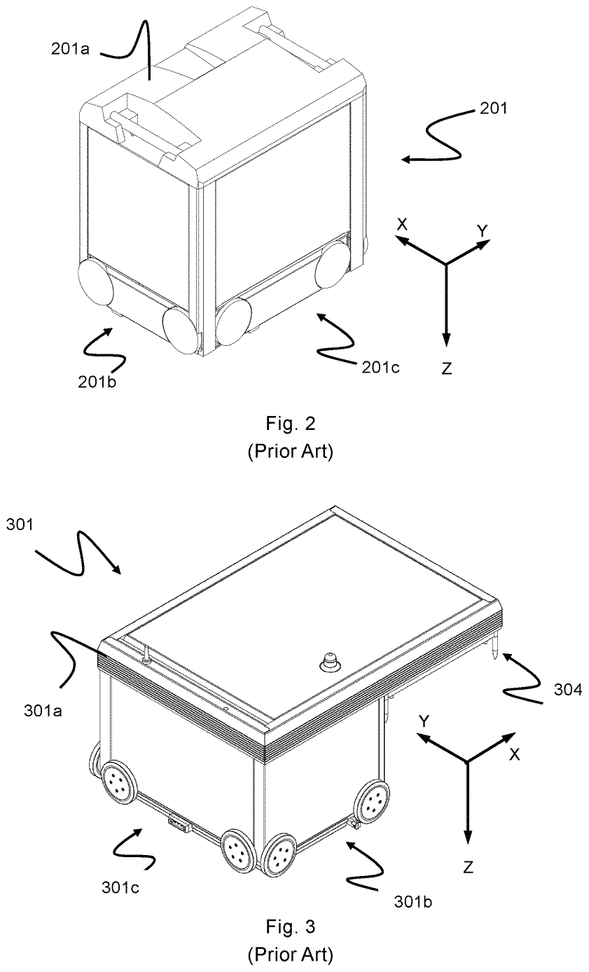

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

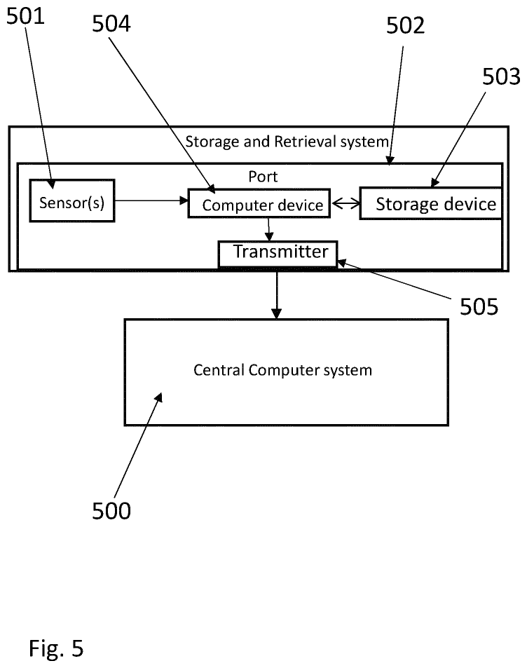

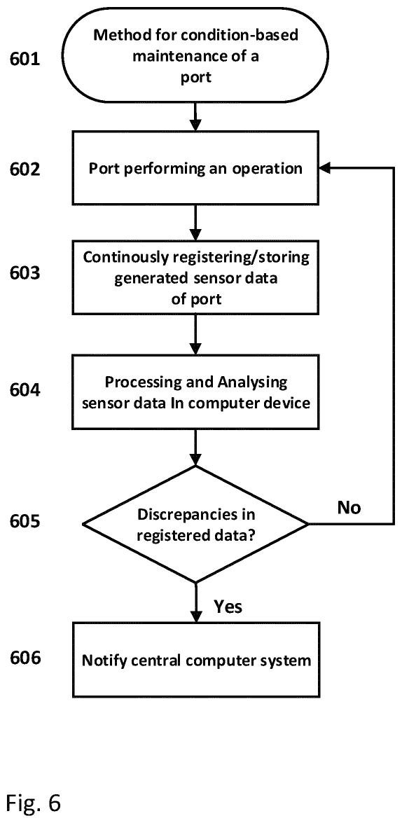

One embodiment of the automated storage and retrieval system according to the invention will now be discussed in more detail with reference to FIGS. 5 and 6

FIG. 5 is a block diagram of the system and how the different pieces fit together. The block diagram illustrates a storage and retrieval system. In the storage and retrieval system there are at least one port. Usually there are more than one port 502. In such a case there would preferably be one computing device 504 for each port 502.

In an embodiment of the present invention the computing device 504 is a computer that is connected to a storage device 505, and arranged to continuously receive, store, and analyse sensor data from the sensors 501. Further there is a transmitter 506 connected to the computing device 504. This is arranged to transmit, to the central computer system 500. The data is analysed using machine learning techniques. By applying deep learning techniques on the collected data from the sensors the computer device can learn to recognise when there is something wrong with the components and parts of the port.

The data is collected by the sensors and stored on a storage device 503. The data can then be analysed by the computer device 504 and the result is transmitted to the central computer system. The central computer system can then make a service schedule based on the analysed information from the computer device.

In another embodiment of the present invention the central computer system 500 is adapted to process and analyse the data using machine learning techniques like deep learning, and initiate maintenance of the identified components and/or parts. In an alternative solution it could also transmit all the recorded data. The transmitting can be done during low or no activity at the port 502.

The sensors 501 monitoring components and parts of the ports 502 can be comprised of one or more of temperature sensor, sound sensor, humidity sensor, vibration sensor, and speed sensor. The sensor data comprise identifications of corresponding monitored components and parts, and where sensor data showing discrepancies from reference sensor data are identified. Also, in an embodiment of the present invention, the computer device can be an edge computing device.

FIG. 6 is a flow chart of the method for condition based maintenance of the ports in a storage and retrieval system.

Here it is described a method for condition-based maintenance of port in a storage and retrieval system. The flowchart shows the basic concept and operation of a computing device connected to sensors arranged to monitor components and parts of ports 502.

When ports 502 performs an operation, the components and parts enabling the operation are being monitored by the sensors generating sensor data. The sensor data are continuously registered and stored in the storage device connected to the computing device in the port 502.

The generated sensor data are continuously processed and analysed. The processing and analysis of the generated sensor data is done by machine learning techniques like deep learning.

During analysis of the sensor data, it is checked if there are data reflecting serious discrepancies from expected sensor data. A serious discrepancy may for instance be that a temperature of a component increases rapidly, or that a new and unexpected sound suddenly occurs.

If a serious discrepancy occurs, the central computer system 500 is notified by transmitting the relevant sensor data to the central computer system 500, which then will further assess the received sensor data and control the port 502 that transmitted the sensor data with discrepancies. How the port 502 then is controlled by the central computer system 500 will be based on the type of fault.

It might be important to continuously and centrally monitor a selected number of sensors that are measuring especially vulnerable components or parts in one or more ports 502. Such sensor data may be continuously transmitted to the central computer system 500 independently of whether a serious deficiency is detected in the sensor data or not.

The automated storage and retrieval system is controlled by a central computer system 500, each port 502 comprises a computing device 504 connected to sensors 501 arranged to monitor components. The computing device continuously receives, stores, and analyses sensor data from the sensors 501. This includes identifications of corresponding components and parts being monitored. Further, the sensor data is compared with reference sensor data. This allows for identifying sensor data showing discrepancies from reference sensor data, and if the sensor data shows discrepancies above a pre-set level. Further, the data representing sensor data above the pre-set level is transmitted from the computing device 504 to the central computer system 500 of the automated storage and retrieval system.

All the sensor data showing discrepancies are transmitted from the computing device 504 to the central computer system 500 of the automated storage and retrieval system when a port 502 has low or no activity.

Identified sensor data showing discrepancies from the reference sensor data can be ranked according to degree of discrepancy, and where only sensor data having the highest degree of discrepancy are transmitted to the central storage system 500 for further analysis when the port 502 has low or no activity.

Also the invention comprises a computer program product that when executed in a processor by a computing device 504 is arranged to monitor operations of a port 502 comprising the computing device 504 which is connected to a storage device 505 and to sensors 501, performs the steps of: continuously receiving, storing, processing and analysing sensor data from the sensors 501, including identifications of corresponding components and parts being monitored, comparing sensor data with reference sensor data and identifying sensor data showing discrepancies from the reference sensor data, determining if the sensor data show discrepancies above a pre-set level, initiating transmission, from the computing device 504 to the central computer system 500 of the automated storage and retrieval system, of data representing sensor data above the pre-set level.

Further, the invention comprises a software program product, that when executed in a central computer system 500 arranged to control and monitor operations of an automated storage and retrieval system performs the steps of: receiving data comprising sensor data from ports 502 operating the automated storage and retrieval system, processing and analysing the sensor data, identifying, and initiating maintenance for components and parts according to type of maintenance needed.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

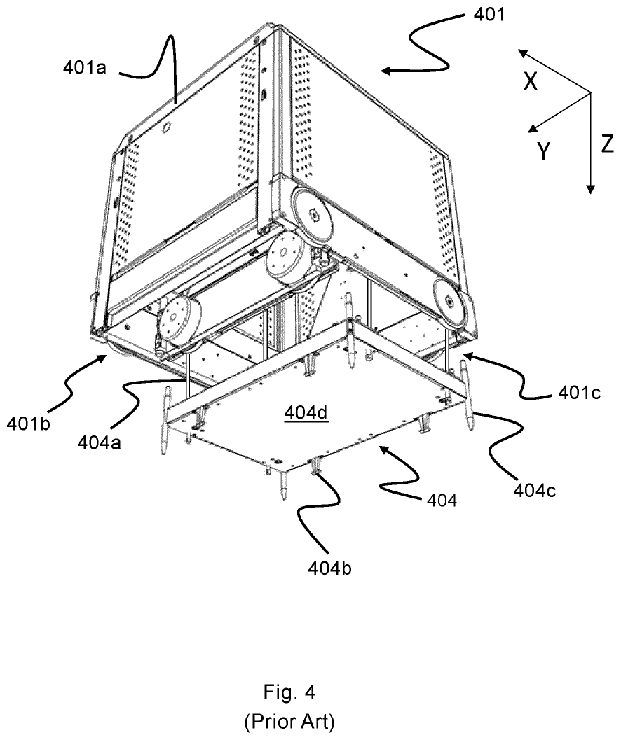

### Prior Art (FIGS. 1-4):

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1-16. (canceled)

17. A system for determining a condition-based maintenance of ports in an automated storage and retrieval system comprising a framework structure with a rail system forming a three-dimensional storage grid structure for storing storage containers for storing items,
wherein the grid structure comprises one or more ports for extracting storage containers from the storage grid structure so that they can be picked,
wherein the automated storage and retrieval system is controlled by a central computer system and each port is connected to sensors arranged to monitor components and/or parts,
wherein the system comprises a transmitter connected to a computing device and/or the sensors for transmitting data to the central computer system,
wherein the computing device is arranged to receive, store, and analyse data from the sensors using machine learning techniques, and
wherein the central computer system is adapted to process and analyse the data from the computing device and/or the sensors to identify components and/or parts for maintenance, and initiate maintenance of the identified components and/or parts.

18. The system according to claim 17, wherein the sensors arranged to monitor components and/or parts of the one or more ports comprises one or more of: a temperature sensor, a sound sensor, a humidity sensor, a vibration sensor, and/or a speed sensor.

19. The system according to claim 17, wherein the computing device uses deep learning techniques on the data to recognize issues at the one or more ports.

20. The system according to claim 17, wherein each port comprises the computing device, and the computing device is arranged to transmit a result of the analysis of the data of a respective port to the central computer system.

21. The system according to claim 17, wherein the computing device is arranged to transmit a result of the analysis of the data of a plurality of ports to the central computer system.

22. The system according to claim 17, wherein the central computer system comprises a service regime manager for creating a service regime.

23. A method for condition-based maintenance of a port in an automated storage and retrieval system comprising a framework structure with a rail system forming a three-dimensional storage grid structure for storing storage containers for storing items,
wherein the grid structure comprises one or more ports for extracting storage containers from the storage grid structure so that they can be picked,
wherein the automated storage and retrieval system is controlled by a central computer system and each port is connected to sensors arranged to monitor components and/or parts, and
wherein the method comprises:
receiving, storing, and analysing data from the sensors at a computing device using machine learning techniques;
transmitting, using a transmitter connected to a computing device and/or the sensors, data to the central computer system;
processing and analyzing, at the central computer system, data from the computing device and/or the sensors which are above a pre-set level to identify components and/or parts for maintenance; and
initiating, based on the analysis of the central computer system, maintenance of the identified components or parts.

24. The method according to claim 23, wherein the data from the sensors comprises a registration of a problem with the component or part of the storage and retrieval system together with information regarding its service time and age.

25. The method according to claim 23, wherein the computing device is configured to store one or more times at which data is recorded by the sensors.

26. The method according to claim 23, wherein data showing discrepancies are transmitted from the computing device to the central computer system when a port has low or no activity.

27. The method according to claim 23, wherein data is transmitted from the computing device to the central computer system when a port has low or no activity.

28. The method according to claim 23, wherein the central computer system comprises a service regime manager for creating a service regime.

29. The method according to claim 23, wherein each port comprises the computing device, and the computing device is arranged to transmit a result of the analysis of the data of a respective port to the central computer system.

30. The method according to claim 23, wherein the computing device is arranged to transmit a result of the analysis of the data of a plurality of ports to the central computer system.

31. A computer program product that, when executed by a processor at a computing device, is arranged to monitor operations of a port by performing the steps of:
receiving, storing, and analyzing data from sensors arranged to monitor components and/or parts of the port; and
transmitting, from the computing device to a central computer system of an automated storage and retrieval system, data from the sensors.

32. A software program product that, when executed on a central computer system, is arranged to control and monitor operations of an automated storage and retrieval system by performing the steps of:
receiving data from sensors arranged to monitor components and/or parts of a port, the port for extracting storage containers from the automated storage and retrieval system;
processing and analyzing the data to identify components and/or parts for maintenance, and initiating maintenance for the identified components and/or parts.
